(19) United States
(12) Patent Application Publication
(10) Pub. No.: US 2014/0044286 A1
(43) Pub. Date: Feb. 13, 2014

(54) DYNAMIC SPEAKER SELECTION FOR MOBILE COMPUTING DEVICES

(71) Applicant: MOTOROLA MOBILITY LLC, Libertyville, IL (US)

(72) Inventors: Katherine H. Coles, Libertyville, IL (US); Vijay L. Asrani, Round Lake, IL (US); Peruvemba Ranganathan Sai Ananthanarayanan, Naperville, IL (US)

(73) Assignee: MOTOROLA MOBILITY LLC, Libertyville, IL (US)

(21) Appl. No.: 13/644,308

(22) Filed: Oct. 4, 2012

Related U.S. Application Data
(60) Provisional application No. 61/681,701, filed on Aug. 10, 2012.

(51) Int. Cl. H04R 23/00

(52) U.S. Cl. 381/150

(57) ABSTRACT

A method is disclosed for optimizing audio performance of a portable electronic device having multiple audio ports. The method can include detecting an orientation of the mobile device. Therefore, the portable electronic device includes a sensor for determining orientation of the portable electronic device; and one or more sensors placed near each audio port for sampling whether each audio port is obstructed; and a processor for activating one or more unobstructed audio ports and deactivating one or more obstructed audio ports.

### BACKGROUND OF THE INVENTION

1. Field of the Invention

The present invention generally relates to mobile computing devices and, more particularly, to generating audio information on a mobile computing device.

2. Background of the Invention

The use of mobile computing devices (sometimes herein referred to as “MCD” or “device”), for example, smart phones, tablet computers, Ultrabook computers, wearable computers, and mobile gaming devices, is prevalent throughout most of the industrialized world. Mobile computing devices commonly are used to present business media, user created media, or entertainment media, such as movies, sports, or music, as well as other audio media. Multimedia presentations can include both audio media and image media. Conventional video games also generate audio media to enhance user experience. A mobile computing device may include one or two output audio transducers, at the very least, (e.g., electro-mechanical loudspeakers). The speakers can be placed in one or more audio ports, to generate output audio signals related to incoming audio media. Mobile computing devices that include two speakers sometimes are configured to present audio signals as stereophonic signals.

When a user of a mobile computing device chooses to switch or reorient their hand grip on the mobile computing device that new location decision could cause the user's hands or fingers to obstruct one or more audio ports. When a user obstructs one or more audio ports, the user does not receive a desirable audio experience, because the sound can be audibly detected as muffled or degraded. Some conventional means of addressing the muffling of the output audio, caused by a user obstruction an audio port, can include orientation-based audio port switching. That is, using an accelerometer to turn on specified default speakers when the mobile computing device's orientation is switched from portrait mode to landscape mode or vice-versa.

However, the user is still required to hold the mobile computing device to avoid blocking or obstructing default speakers that may exist on the device. For example, the default speakers may be at the top of the mobile computing device, which is a preferable hold location to some users of mobile computing devices; but the user that prefers the top location for holding the device is forced to alter her grip away from the top location and the default speakers when the mobile computing device is switched in orientation.

### BRIEF DESCRIPTION OF THE DRAWINGS

Preferred embodiments of the present invention will be described below in more detail, with reference to the accompanying drawings, in which:

FIGS. 1a-1d depict a front view of a mobile computing device illustrating an example audio port orientation;

FIGS. 2a-2d depict a front view of another example embodiment of audio port orientation for the mobile computing device of FIG. 1;

FIGS. 3a-3d depict a front view of another example embodiment of audio port orientation for the mobile device of FIG. 1;

FIGS. 4a-4d depict a front view of another example embodiment of audio port orientation for the mobile device of FIG. 1;

FIG. 5A is a flowchart illustrating an example methodology that is useful for understanding the present arrangements;

FIG. 5B illustrates example range assignments and actions for an audio port;

FIG. 6 is an example block diagram that is useful for understanding the present arrangements; and

FIG. 7 is a flowchart illustrating an example methodology that is useful for understanding the present arrangements.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather to provide an understandable description of the invention.

Example embodiments described herein relate to the use of two or more speakers on a mobile computing device to present audio media using stereophonic (hereinafter “stereo”) audio signals. Mobile computing devices oftentimes are configured so that they can be rotated from a landscape orientation to a portrait orientation, rotated in a top-side down orientation, etc. In a typical mobile computing device with stereo capability, a first output audio transducer (e.g., loudspeakers) located on a left side of the mobile device is dedicated to left channel audio signals, and a second output audio transducer located on a right side of the mobile device is dedicated to right channel audio signals. Thus, if the mobile device is rotated from a landscape orientation to a portrait orientation, the first and second speakers may be vertically aligned, thereby impacting the placement of a user's hands or fingers in order to grip the mobile computing device.

Moreover, the present arrangements also can dynamically select which input audio transducer(s) (e.g., microphones) of the mobile device are used to receive the right channel audio signals and which input audio transducer(s) are used to receive the left channel audio signals based on the orientation of the mobile device. Accordingly, the present invention maintains proper stereo separation of input audio signals, regardless of the position in which the mobile device is oriented.

By way of example, one arrangement relates to a portable electronic device that includes multiple audio ports. The portable electronic device further includes at least one sensor for determining orientation of the portable electronic device; and other sensors that are placed near each audio port for sampling whether each audio port is obstructed. A processor is operably configured to activate one or more unobstructed audio ports and deactivate one or more obstructed audio ports.

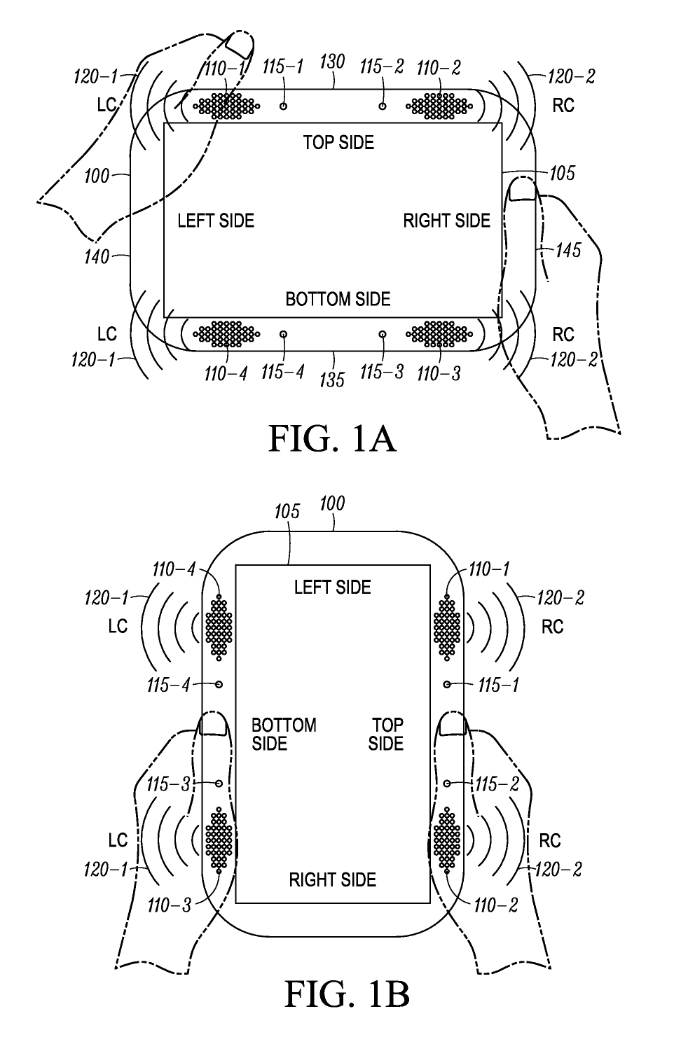

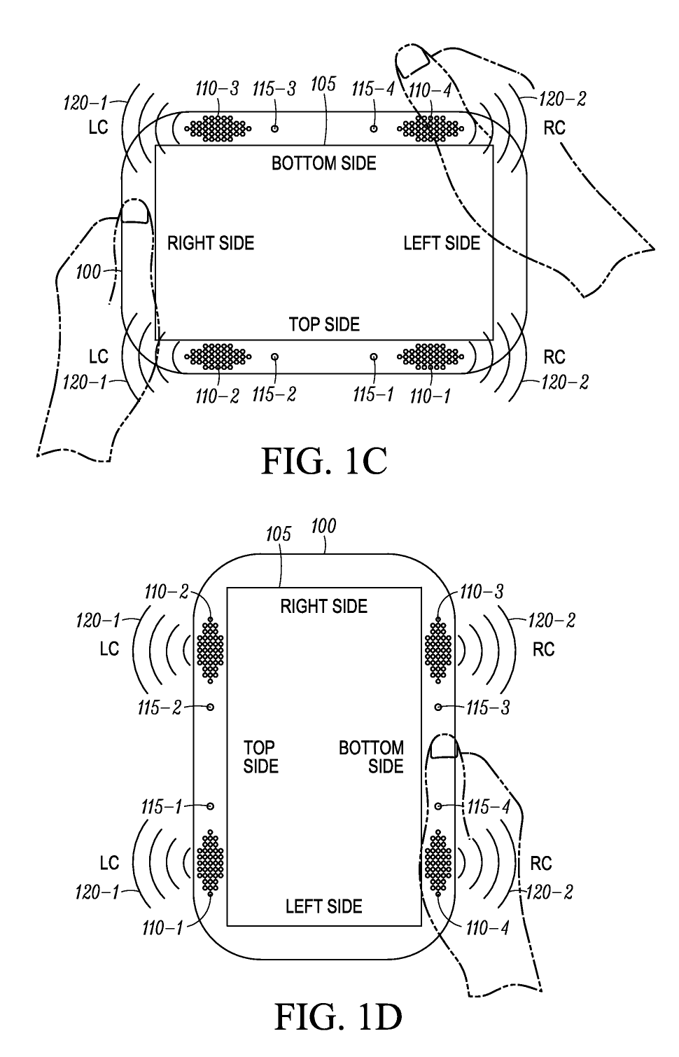

FIGS. 1a-1d depict an example front view of a mobile computing device 100 having several audio ports displaced around the perimeter of mobile computing device. The mobile device 100 can be a tablet computer, a smart phone, a mobile gaming device, an Ultrabook, a wearable computing device, or any other portable electronic device that can output or receive audio signals. The mobile computing device 100 can include a display 105. The display 105 can be a touchscreen, or any other suitable display. The mobile computing device 100 further can include a plurality of output audio transducers 110 and a plurality of input audio transducers 115.

Referring to FIG. 1a, the output audio transducers 110-1, 110-2 and input audio transducers 115-1, 115-2 can be vertically positioned at, or proximate to, a top side of the mobile or portable computing device 100, for example at, or proximate to, an upper peripheral edge 130 of the mobile computing device 100. The output audio transducers 110-3, 110-4 and input audio transducers 115-3, 115-4 can be vertically positioned at, or proximate to, a bottom side of the mobile computing device 100, for example at, or proximate to, a lower peripheral edge 135 of the mobile computing device 100. Further, the output audio transducers 110-1, 110-4 and input audio transducers 115-1, 115-4 can be horizontally positioned at, or proximate to, a left side of the mobile computing device 100, for example at, or proximate to, a left peripheral edge 140 of the mobile computing device 100. The output audio transducers 110-2, 110-3 and input audio transducers 115-2, 115-3 can be horizontally positioned at, or proximate to, a right side of the mobile computing device 100, for example at, or proximate to a right peripheral edge 145 of the mobile computing device 100. In one embodiment, one or more of the output audio transducers 110 or input audio transducers 115 can be positioned at respective corners of the mobile device 100. Each input audio transducers 115 can be positioned approximately near a respective output audio transducer, though this need not be the case. Additionally, an audio port can include an electro-mechanical speaker or transducer, or alternatively the audio port can emanate sound or an audio signal without a speaker or transducer. The audio port, therefore, can be comprised of a technology that also produces sound or audio signals. Additionally, the audio port can be located a distance away from the transducer, as for example, porting audio from the sides or edges of the device and away from a microphone that may be placed in front of the device.

While using the mobile device 100, a user can orient the mobile device in any desired orientation by rotating the mobile device 100 about an axis perpendicular to the surface of the display 105. For example, FIG. 1a depicts the mobile device 100 in a top side-up landscape orientation, FIG. 1b depicts the mobile device 100 in a left side-up portrait orientation, FIG. 1c depicts the mobile device 100 in a bottom side-up (i.e., top side-down) landscape orientation, and FIG. 1d depicts the mobile device in a right side-up portrait orientation. In FIGS. 1a-1d, respective sides of the display 105 have been identified as top side, right side, bottom side and left side.

Notwithstanding, several different orientations are contemplated, and thus are not therefore limited to these illustrative examples. For example, the side of the display 105 indicated as being the left side can be the top side, the side of the display 105 indicated as being the top side can be the right side, the side of the display 105 indicated as being the right side can be the bottom side, and the side of the display 105 indicated as being the bottom side can be the left side.

Moreover, although four output audio transducers are depicted, one embodiment can be applied to a mobile computing device having two output audio transducers, three output audio transducers, or more than four output audio transducers. Similarly, although four input audio transducers are depicted, one embodiment can be applied to a mobile computing device having two input audio transducers, three input audio transducers, or more than four input audio transducers.

Additionally, at least one or more output audio transducers may be located in the center of the device or at a location slight off-centered for a portable electronic device, such as mobile computing device 100, for example.

Referring to FIG. 1a, when the mobile computing device 100 is in the top side-up landscape orientation, the mobile device 100 can be configured to dynamically select the output audio transducer 110-1 and/or the output audio transducer 110-4 to output left channel audio signals 120-1 and dynamically select the output audio transducer 110-2 and/or the output audio transducer 110-3 to output right channel audio signals 120-2. Accordingly, when playing audio media, for example audio media from an audio presentation/recording or audio media from a multimedia presentation/recording, the mobile computing device can communicate left channel audio signals 120-1 to the output audio transducer 110-1 and/or the output audio transducer 110-4 for presentation to the user and communicate right channel audio signals 120-2 to the output audio transducer 110-2 and/or the output audio transducer 110-3 for presentation to the user.

Similarly, the mobile device 100 can be configured to dynamically select the input audio transducer 115-1 and/or the input audio transducer 115-4 to receive left channel audio signals and dynamically select the input audio transducer 115-2 and/or the input audio transducer 115-3 to receive right channel audio signals. Accordingly, when receiving audio media, for example, audio media can be generated or created by a user. Additionally, other audio media can include audio media that the user wishes to capture with the mobile computing device 100, the mobile device can receive left channel audio signals from the input audio transducer 115-1 and/or the input audio transducer 115-4 and receive right channel audio signals from the input audio transducer 115-2 and/or the input audio transducer 115-3.

Referring to FIG. 1b, when the mobile device 100 is in the left side-up portrait orientation, the mobile device 100 can be configured to dynamically select the output audio transducer 110-3 and/or the output audio transducer 110-4 to output left channel audio signals 120-1 and dynamically select the output audio transducer 110-1 and/or the output audio transducer 110-2 to output right channel audio signals 120-2. Accordingly, when playing audio media, the mobile device can communicate left channel audio signals 120-1 to the output audio transducer 110-3 and/or the output audio transducer 110-4 for presentation to the user and communicate right channel audio signals 120-2 to the output audio transducer 110-1 and/or the output audio transducer 110-2 for presentation to the user.

Similarly, the mobile device 100 can be configured to dynamically select the input audio transducer 115-3 and/or the input audio transducer 115-4 to receive left channel audio signals and dynamically select the input audio transducer 115-1 and/or the input audio transducer 115-2 to receive right channel audio signals. Accordingly, when receiving audio media, the mobile device can receive left channel audio signals from the input audio transducer 115-3 and/or the input audio transducer 115-4 and receive right channel audio signals from the input audio transducer 115-1 and/or the input audio transducer 115-2.

Referring to FIG. 1c, when the mobile device 100 is in the bottom side-up landscape orientation, the mobile device 100 can be configured to dynamically select the output audio transducer 110-2 and/or the output audio transducer 110-3 to output left channel audio signals 120-1 and dynamically select the output audio transducer 110-1 and/or the output audio transducer 110-4 to output right channel audio signals 120-2. Accordingly, when playing audio media, the mobile device can communicate left channel audio signals 120-1 to the output audio transducer 110-2 and/or the output audio transducer 110-3 for presentation to the user and communicate right channel audio signals 120-2 to the output audio transducer 110-1 and/or the output audio transducer 110-4 for presentation to the user.

Similarly, the mobile device 100 can be configured to dynamically select the input audio transducer 115-2 and/or the input audio transducer 115-3 to receive left channel audio signals and dynamically select the input audio transducer 115-1 and/or the input audio transducer 115-4 to receive right channel audio signals. Accordingly, when receiving audio media, the mobile device can receive left channel audio signals from the input audio transducer 115-2 and/or the input audio transducer 115-3 and receive right channel audio signals from the input audio transducer 115-1 and/or the input audio transducer 115-4.

Referring to FIG. 1d, when the mobile device 100 is in the top side-up landscape orientation, the mobile device 100 can be configured to dynamically select the output audio transducer 110-1 and/or the output audio transducer 110-2 to output left channel audio signals 120-1 and dynamically select the output audio transducer 110-3 and/or the output audio transducer 110-4 to output right channel audio signals 120-2. Accordingly, when playing audio media, the mobile device can communicate left channel audio signals 120-1 to the output audio transducer 110-1 and/or the output audio transducer 110-2 for presentation to the user and communicate right channel audio signals 120-2 to the output audio transducer 110-3 and/or the output audio transducer 110-4 for presentation to the user.

Similarly, the mobile device 100 can be configured to dynamically select the input audio transducer 115-1 and/or the input audio transducer 115-2 to receive left channel audio signals and dynamically select the input audio transducer 115-3 and/or the input audio transducer 115-4 to receive right channel audio signals. Accordingly, when receiving audio media, the mobile device can receive left channel audio signals from the input audio transducer 115-1 and/or the input audio transducer 115-2 and receive right channel audio signals from the input audio transducer 115-3 and/or the input audio transducer 115-4.

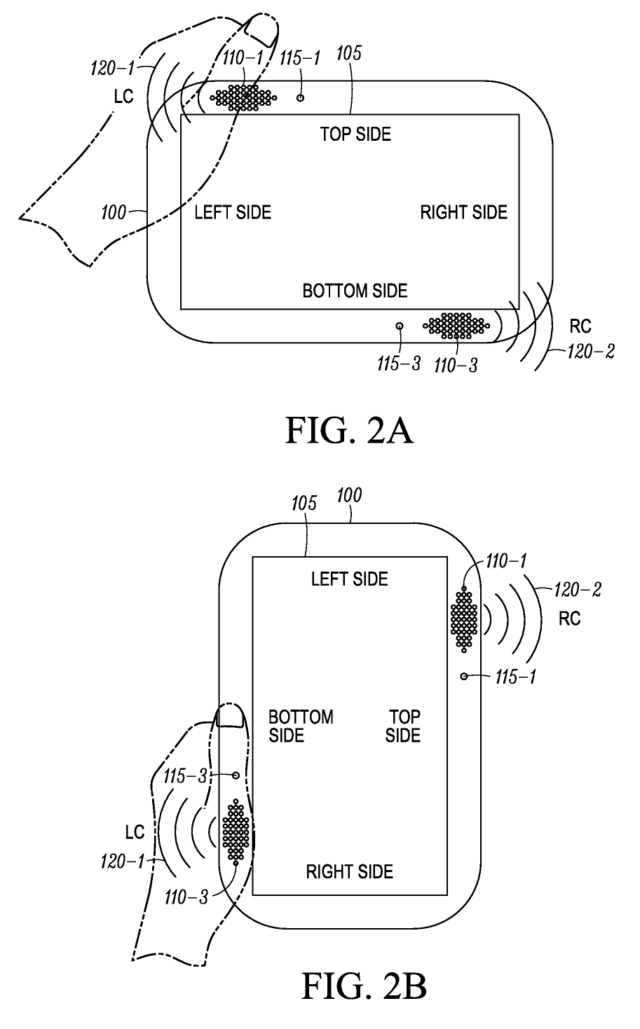

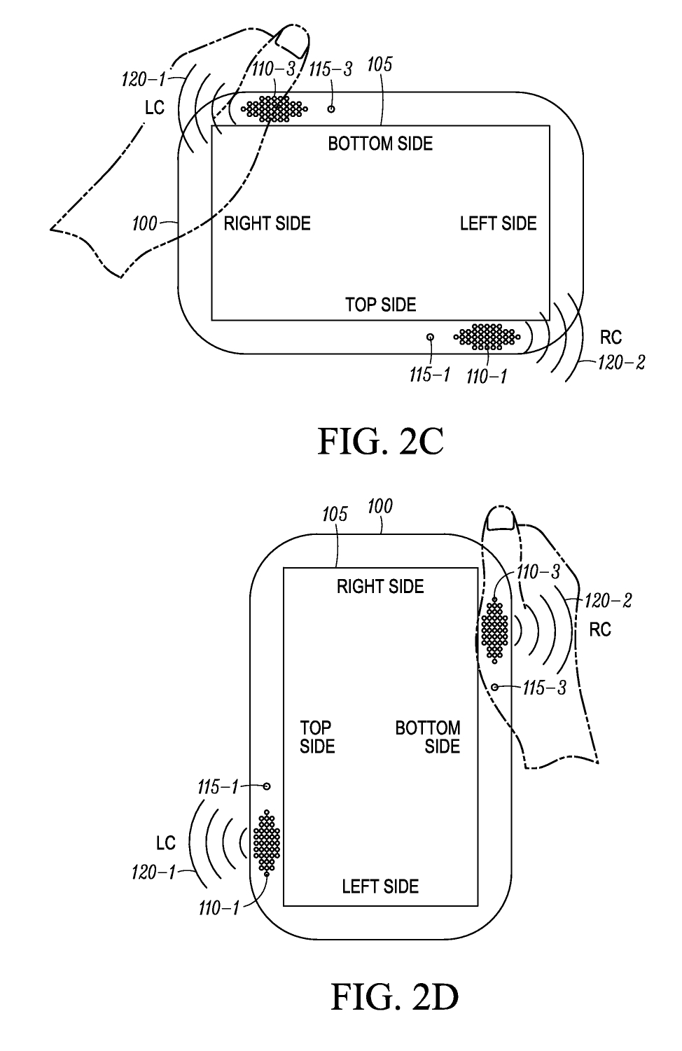

FIGS. 2a-2d depict a front view of another embodiment of a portable electronic device such as the mobile device 100 of FIG. 1, in various orientations. In comparison to FIG. 1, in FIG. 2 the mobile device 100 includes the output audio transducers 110-1, 110-3, but does not include the output audio transducers 110-2, 110-4. Similarly, in FIG. 2 the mobile device 100 includes the input audio transducers 115-1, 115-3, but does not include the input audio transducers 115-2, 115-4.

FIG. 2a depicts the mobile device 100 in a top side-up landscape orientation, FIG. 2b depicts the mobile device 100 in a left side-up portrait orientation, FIG. 2c depicts the mobile device 100 in a bottom side-up (i.e., top side-down) landscape orientation, and FIG. 2d depicts the mobile device in a right side-up portrait orientation.

Referring to FIGS. 2a and 2d, when the mobile device 100 is in the top side-up landscape orientation or in the right side-up portrait orientation, the mobile device 100 can be configured to dynamically select the output audio transducer 110-1 to output left channel audio signals 120-1 and dynamically select the output audio transducer 110-3 to output right channel audio signals 120-2. Accordingly, when playing audio media, the mobile device can communicate left channel audio signals 120-1 to the output audio transducer 110-1 for presentation to the user and communicate right channel audio signals 120-2 to the output audio transducer 110-3 for presentation to the user.

Similarly, the mobile device 100 can be configured to dynamically select the input audio transducer 115-1 to receive left channel audio signals and dynamically select the input audio transducer 115-3 to receive right channel audio signals. Accordingly, when receiving audio media, the mobile device can receive left channel audio signals from the input audio transducer 115-1 and receive right channel audio signals from the input audio transducer 115-3.

Referring to FIGS. 2b and 2c, when the mobile device 100 is in the left side-up portrait orientation or the bottom side-up landscape orientation, the mobile device 100 can be configured to dynamically select the output audio transducer 110-3 to output left channel audio signals 120-1 and dynamically select the output audio transducer 110-1 to output right channel audio signals 120-2. Accordingly, when playing audio media, the mobile device can communicate left channel audio signals 120-1 to the output audio transducer 110-3 for presentation to the user and communicate right channel audio signals 120-2 to the output audio transducer 110-1 for presentation to the user.

Similarly, the mobile device 100 can be configured to dynamically select the input audio transducer 115-3 to receive left channel audio signals and dynamically select the input audio transducer 115-1 to receive right channel audio signals. Accordingly, when receiving audio media, the mobile device can receive left channel audio signals from the input audio transducer 115-3 and receive right channel audio signals from the input audio transducer 115-1.

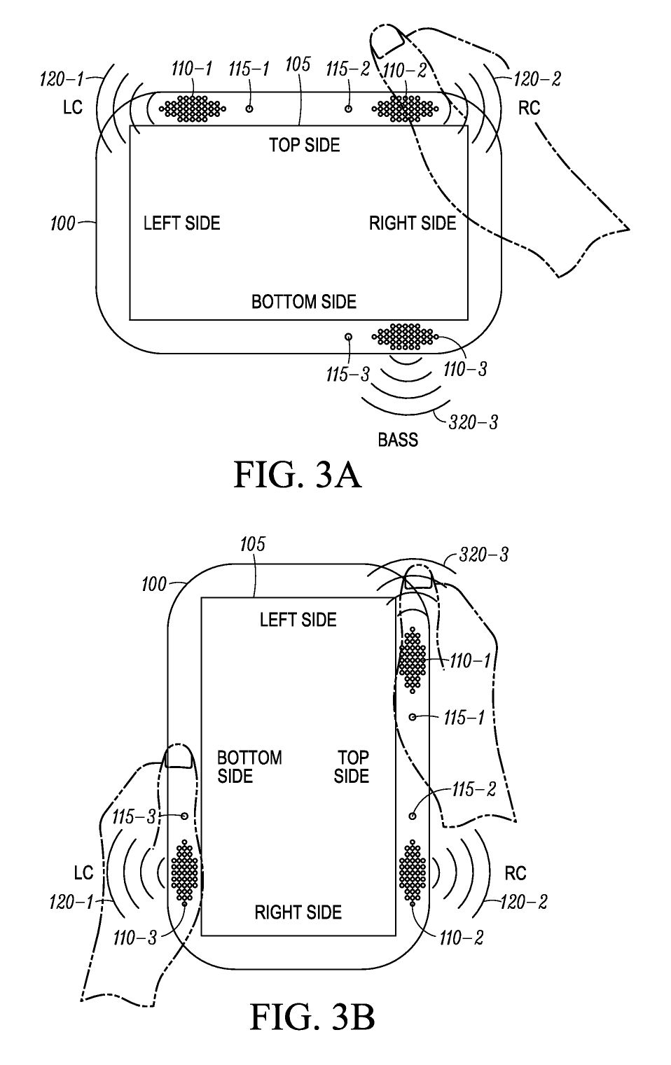

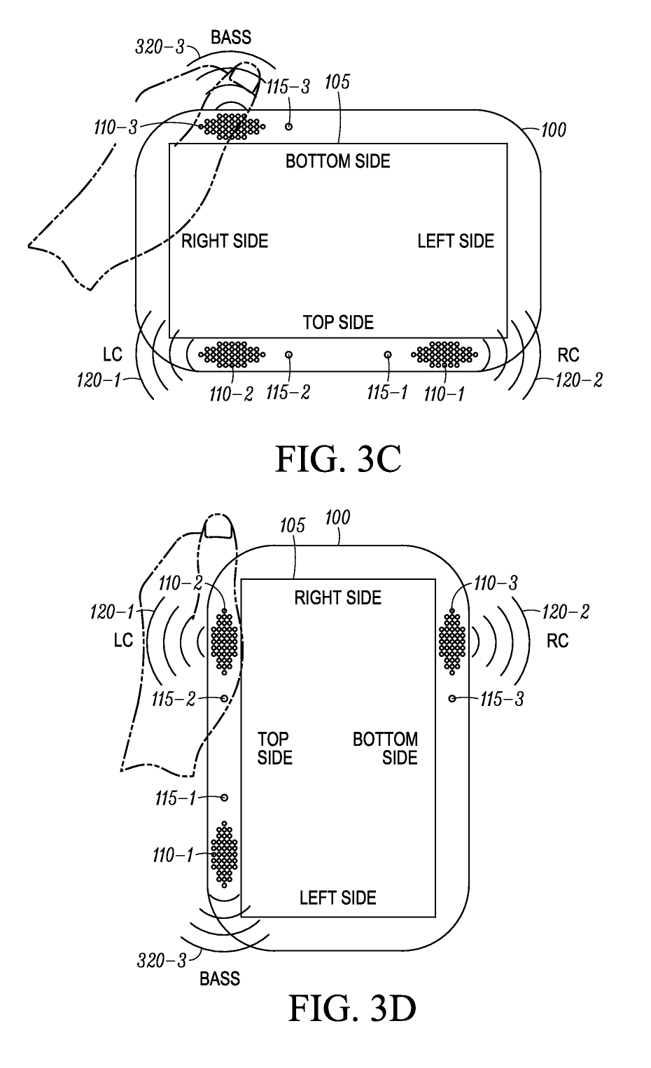

FIGS. 3a-3d depict a front view of another embodiment of the mobile device 100 of FIG. 1, in various orientations. In comparison to FIG. 1, in FIG. 3 the mobile device 100 includes the output audio transducers 110-1, 110-2, 110-3, but does not include the output audio transducer 110-4. Similarly, in FIG. 3 the mobile device 100 includes the input audio transducers 115-1, 115-2, 115-3, but does not include the input audio transducer 115-4.

FIG. 3a depicts the mobile device 100 in a top side-up landscape orientation, FIG. 3b depicts the mobile device 100 in a left side-up portrait orientation, FIG. 3c depicts the mobile device 100 in a bottom side-up (i.e., top side-down) landscape orientation, and FIG. 3d depicts the mobile device in a right side-up portrait orientation.

Referring to FIG. 3a, when the mobile device 100 is in the top side-up landscape orientation, the mobile device 100 can be configured to dynamically select the output audio transducer 110-1 to output left channel audio signals 120-1 and dynamically select the output audio transducer 110-2 to output right channel audio signals 120-2.

Further, the mobile device 100 can be configured to dynamically select the output audio transducer 110-3 to output bass audio signals 320-3. The bass audio signals 320-3 can be presented as a monophonic audio signal. In one arrangement, the bass audio signals 320-3 can comprise portions of the left and/or right channel audio signals 120-1, 120-2 that are below a certain cutoff frequency, for example below 250 Hz, below 200 Hz, below 150 Hz, below 120 Hz, below 100 Hz, below 80 Hz, or the like. In this regard, the bass audio signals 320-3 can include portions of both the left and right channel audio signals 120-1, 120-2 that are below the cutoff frequency, or portions of either the left channel audio signals 120-1 or right channel audio signals 120-2 that are below the cutoff frequency. A filter, also known in the art as a cross-over, can be applied to filter the left and/or right channel audio signals 120-1, 120-2 to remove signals above the cutoff frequency to produce the bass audio signal 320-3. In another arrangement, the bass audio signals 320-3 can be received from a media application as an audio channel separate from the left and right audio channels 120-1, 120-2.

In one arrangement, the output audio transducers 110-1, 110-2 outputting the respective left and right audio channel signals 120-1, 120-2 can receive the entire bandwidth of the respective audio channels, in which case the bass audio signal 320-3 output by the output audio transducer 110-3 can enhance the bass characteristics of the audio media. In another arrangement, filters can be applied to the left and/or right channel audio channel signals 120-1, 120-2 to remove frequencies below the cutoff frequency.

Accordingly, when playing audio media for presentation to the user, the mobile device can communicate left channel audio signals 120-1 to the output audio transducer 110-1, communicate right channel audio signals 120-2 to the output audio transducer 110-2, and communicate bass audio signals 320-3 to the output audio transducer 110-3.

Similarly, the mobile device 100 can be configured to dynamically select the input audio transducer 115-1 to receive left channel audio signals and dynamically select the input audio transducer 115-2 to receive right channel audio signals. Accordingly, when receiving audio media, for example audio media generated by a user or other audio media the user wishes to capture with the mobile device 100, the mobile device can receive left channel audio signals from the input audio transducer 115-1 and receive right channel audio signals from the input audio transducer 115-2.

Referring to FIG. 3b, when the mobile device 100 is in the left side-up portrait orientation, the mobile device 100 can be configured to dynamically select the output audio transducer 110-3 to output left channel audio signals 120-1, dynamically select the output audio transducer 110-2 to output right channel audio signals 120-2, and dynamically select the output audio transducer 110-1 to output bass audio signals 320-3. Accordingly, when playing audio media for presentation to the user, the mobile device can communicate left channel audio signals 120-1 to the output audio transducer 110-3, communicate right channel audio signals 120-2 to the output audio transducer 110-2 and communicate bass audio signals 320-3 to the output audio transducer 110-1.

Similarly, the mobile device 100 can be configured to dynamically select the input audio transducer 115-3 to receive left channel audio signals and dynamically select the input audio transducer 115-2 to receive right channel audio signals. Accordingly, when receiving audio media, the mobile device can receive left channel audio signals from the input audio transducer 115-3 and receive right channel audio signals from the input audio transducer 115-2.

Referring to FIG. 3c, when the mobile device 100 is in the bottom side-up landscape orientation, the mobile device 100 can be configured to dynamically select the output audio transducer 110-2 to output left channel audio signals 120-1, dynamically select the output audio transducer 110-1 to output right channel audio signals 120-2, and dynamically select the output audio transducer 110-3 to output bass audio signals 320-3. Accordingly, when playing audio media for presentation to the user, the mobile device can communicate left channel audio signals 120-1 to the output audio transducer 110-2, communicate right channel audio signals 120-2 to the output audio transducer 110-1, and output bass audio signals 320-3 to the output audio transducer 110-3.

Similarly, the mobile device 100 can be configured to dynamically select the input audio transducer 115-2 to receive left channel audio signals and dynamically select the input audio transducer 115-1 to receive right channel audio signals. Accordingly, when receiving audio media, the mobile device can receive left channel audio signals from the input audio transducer 115-2 and receive right channel audio signals from the input audio transducer 115-1.

Referring to FIG. 3d, when the mobile device 100 is in the top side-up landscape orientation, the mobile device 100 can be configured to dynamically select the output audio transducer 110-2 to output left channel audio signals 120-1, dynamically select the output audio transducer 110-3 to output right channel audio signals 120-2, and dynamically select the output audio transducer 110-1 to output bass audio signals 320-3. Accordingly, when playing audio media for presentation to the user, the mobile device can communicate left channel audio signals 120-1 to the output audio transducer 110-2, communicate right channel audio signals 120-2 to the output audio transducer 110-3, and communicate bass audio signals 320-3 to the output audio transducer 110-1.

Similarly, the mobile device 100 can be configured to dynamically select the input audio transducer 115-2 to receive left channel audio signals and dynamically select the input audio transducer 115-3 to receive right channel audio signals. Accordingly, when receiving audio media, the mobile device can receive left channel audio signals from the input audio transducer 115-2 and receive right channel audio signals from the input audio transducer 115-3.

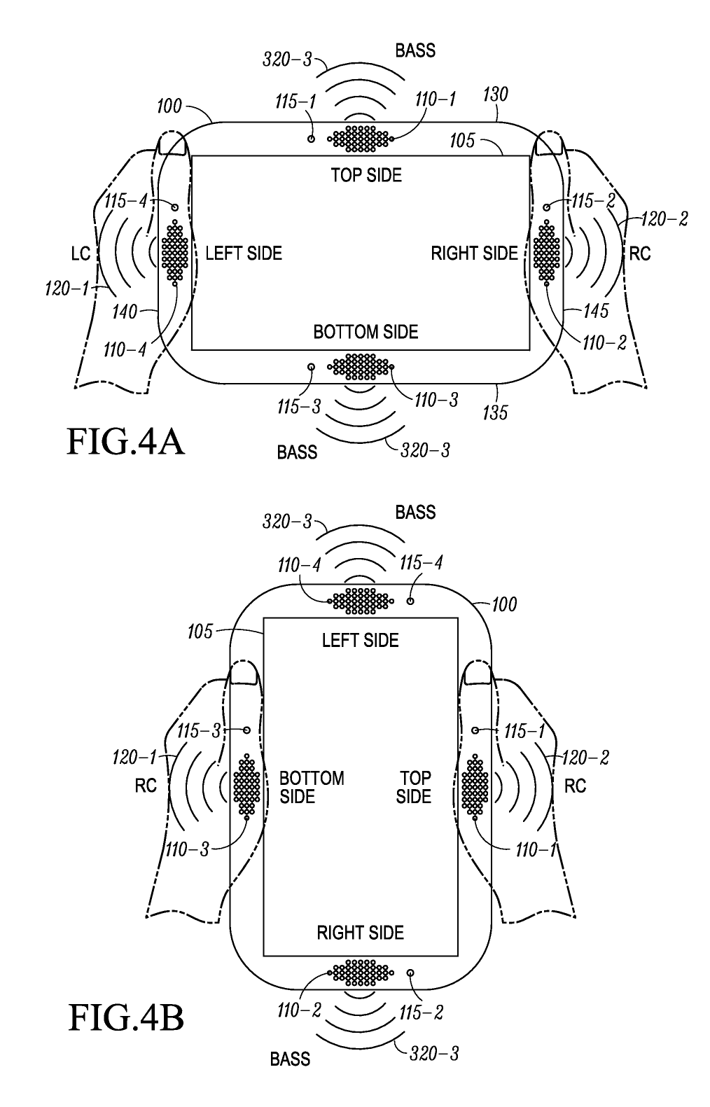

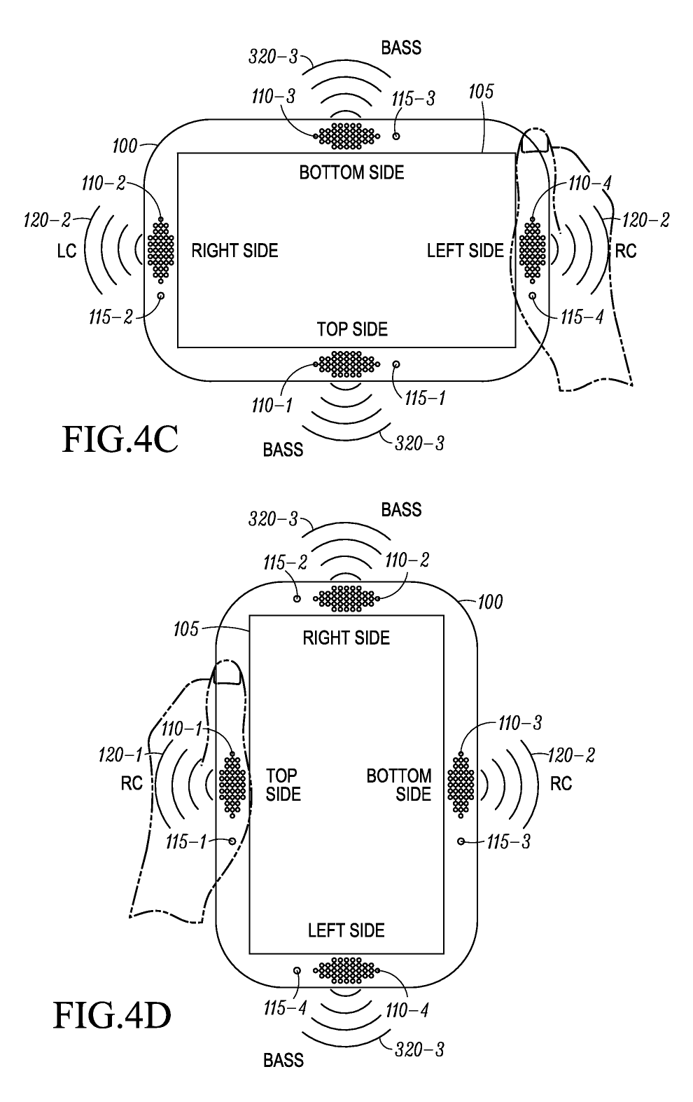

FIGS. 4a-4d depict a front view of another embodiment of the mobile device 100 of FIG. 1, in various orientations. In comparison to FIG. 1, in FIG. 4 the output audio transducers 110 and input audio transducers 115 are positioned at different locations on the mobile device 100. Referring to FIG. 4a, the output audio transducer 110-1 and input audio transducer 115-1 can be vertically positioned at, or proximate to, a top side of the mobile device 100, for example at, or proximate to, an upper peripheral edge 130 of the mobile device 100. The output audio transducer 110-3 and input audio transducer 115-3 can be vertically positioned at, or proximate to, a bottom side of the mobile device 100, for example at, or proximate to, a lower peripheral edge 135 of the mobile device 100. Further, the output audio transducers 110-1, 110-3 and input audio transducers 115-1, 115-3 horizontally can be approximately centered with respect to the right and left sides of the mobile device. Each of the input audio transducers 115-1, 115-3 can be positioned approximately near a respective output audio transducer 110-1, 110-3, though this need not be the case.

The output audio transducer 110-2 and input audio transducer 115-2 can be horizontally positioned at, or proximate to, a right side of the mobile device 100, for example at, or proximate to, a right peripheral edge 145 of the mobile device 100. The output audio transducer 110-4 and input audio transducer 115-4 can be horizontally positioned at, or proximate to, a left side of the mobile device 100, for example at, or proximate to, a left peripheral edge 140 of the mobile device 100. Further, the output audio transducers 110-2, 110-4 and input audio transducers 115-2, 115-4 vertically can be approximately centered with respect to the top and bottom sides of the mobile device. Each of the input audio transducers 115-2, 115-4 can be positioned approximately near a respective output audio transducer 110-2, 110-4, though this need not be the case.

FIG. 4a depicts the mobile device 100 in a top side-up landscape orientation, FIG. 4b depicts the mobile device 100 in a left side-up portrait orientation, FIG. 4c depicts the mobile device 100 in a bottom side-up (i.e., top side-down) landscape orientation, and FIG. 4d depicts the mobile device in a right side-up portrait orientation.

Referring to FIG. 4a, when the mobile device 100 is in the top side-up landscape orientation, the mobile device 100 can be configured to dynamically select the output audio transducer 110-4 to output left channel audio signals 120-1 and dynamically select the output audio transducer 110-2 to output right channel audio signals 120-2. Accordingly, when playing audio media, the mobile device can communicate left channel audio signals 120-1 to the output audio transducer 110-4 for presentation to the user and communicate right channel audio signals 120-2 to the output audio transducer 110-2 for presentation to the user. Further, the mobile device 100 can be configured to dynamically select the output audio transducers 110-1, 110-3 to output bass audio signals 320-3.

Similarly, the mobile device 100 can be configured to dynamically select the input audio transducer 115-4 to receive left channel audio signals and dynamically select the input audio transducer 115-2 to receive right channel audio signals. Accordingly, when receiving audio media, the mobile device can receive left channel audio signals from the input audio transducer 115-4 and receive right channel audio signals from the input audio transducer 115-2.

Referring to FIG. 4b, when the mobile device 100 is in the left side-up portrait orientation, the mobile device 100 can be configured to dynamically select the output audio transducer 110-3 to output left channel audio signals 120-1 and dynamically select the output audio transducer 110-1 to output right channel audio signals 120-2. Accordingly, when playing audio media, the mobile device can communicate left channel audio signals 120-1 to the output audio transducer 110-3 for presentation to the user and communicate right channel audio signals 120-2 to the output audio transducer 110-1 for presentation to the user. Further, the mobile device 100 can be configured to dynamically select the output audio transducers 110-2, 110-4 to output bass audio signals 320-3.

Similarly, the mobile device 100 can be configured to dynamically select the input audio transducer 115-3 to receive left channel audio signals and dynamically select the input audio transducer 115-1 to receive right channel audio signals. Accordingly, when receiving audio media, the mobile device can receive left channel audio signals from the input audio transducer 115-3 and receive right channel audio signals from the input audio transducer 115-1.

Referring to FIG. 4c, when the mobile device 100 is in the bottom side-up landscape orientation, the mobile device 100 can be configured to dynamically select the output audio transducer 110-2 to output left channel audio signals 120-1 and dynamically select the output audio transducer 110-4 to output right channel audio signals 120-2. Accordingly, when playing audio media, the mobile device can communicate left channel audio signals 120-1 to the output audio transducer 110-2 for presentation to the user and communicate right channel audio signals 120-2 to the output audio transducer 110-4 for presentation to the user. Further, the mobile device 100 can be configured to dynamically select the output audio transducers 110-1, 110-3 to output bass audio signals 320-3.

Similarly, the mobile device 100 can be configured to dynamically select the input audio transducer 115-2 to receive left channel audio signals and dynamically select the input audio transducer 115-4 to receive right channel audio signals. Accordingly, when receiving audio media, the mobile device can receive left channel audio signals from the input audio transducer 115-2 and receive right channel audio signals from the input audio transducer 115-4.

Referring to FIG. 4d, when the mobile device 100 is in the right side-up portrait orientation, the mobile device 100 can be configured to dynamically select the output audio transducer 110-1 to output left channel audio signals 120-1 and dynamically select the output audio transducer 110-3 to output right channel audio signals 120-2. Accordingly, when playing audio media, the mobile device can communicate left channel audio signals 120-1 to the output audio transducer 110-1 for presentation to the user and communicate right channel audio signals 120-2 to the output audio transducer 110-3 for presentation to the user. Further, the mobile device 100 can be configured to dynamically select the output audio transducers 110-2, 110-4 to output bass audio signals 320-3.

Similarly, the mobile device 100 can be configured to dynamically select the input audio transducer 115-1 to receive left channel audio signals and dynamically select the input audio transducer 115-3 to receive right channel audio signals. Accordingly, when receiving audio media, the mobile device can receive left channel audio signals from the input audio transducer 115-1 and receive right channel audio signals from the input audio transducer 115-3.

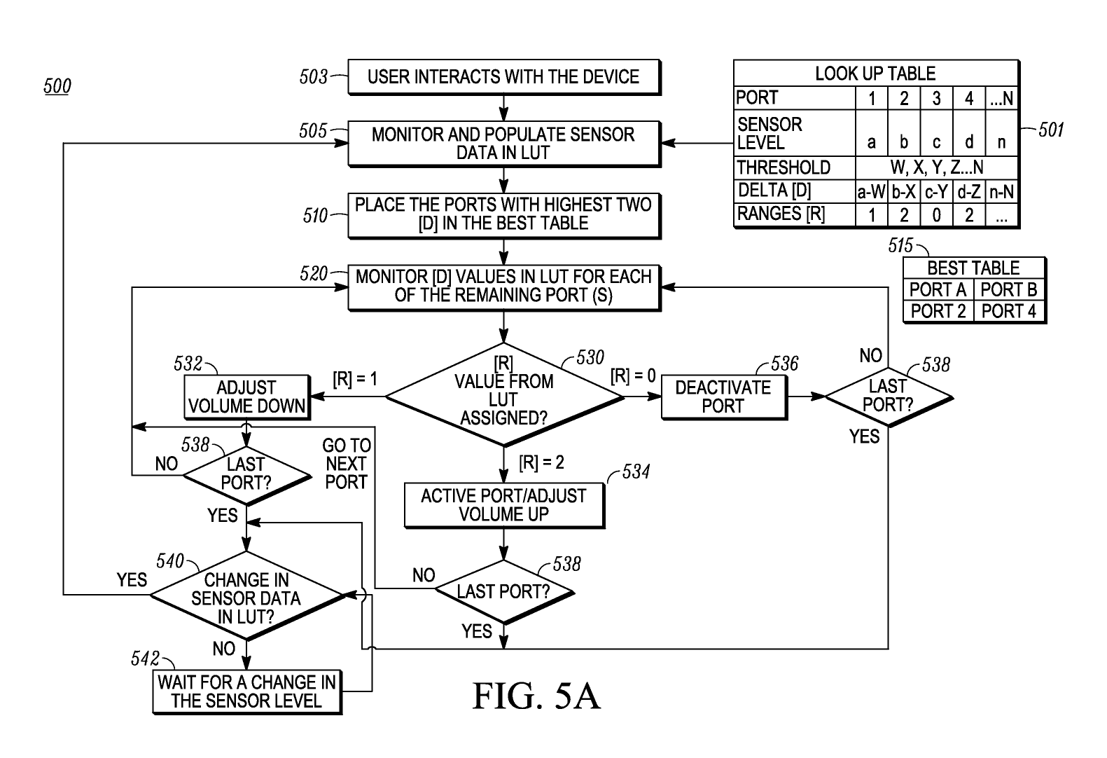

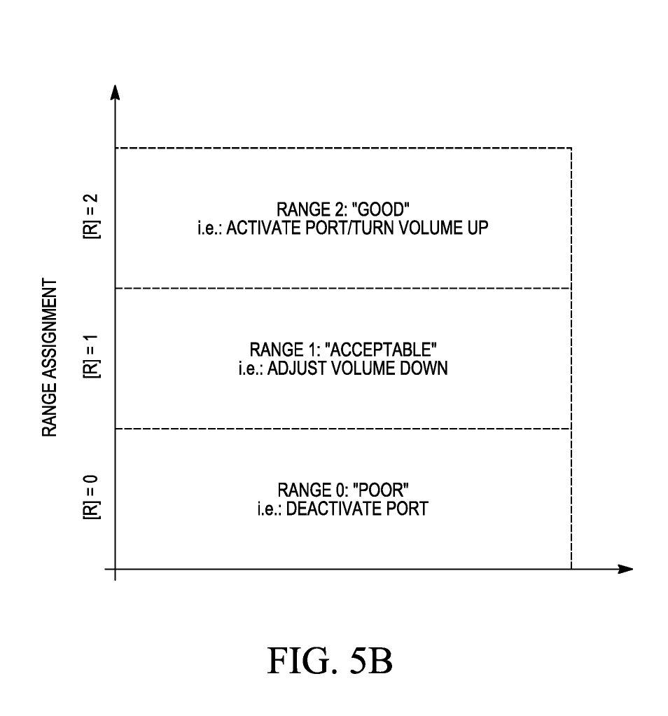

FIG. 5A is a flowchart 500 illustrating an example methodology that is useful for understanding the present arrangements. Notably, a change in orientation or any user input received by a portable electronic device may cause one or more sensors to be sampled by a processor communicatively coupled with a look-up table (LUT) 501. The LUT 501 is populated with audio port information. Initially, the LUT 501 may be pre-populated with audio port information. LUT 501 may include both input sensor data and output sensor data. However, any sensor data is non-transitory and can be over-written, but is preferably not erased.

In addition, LUT 501 includes delta values [D], range values [R], and threshold values for each audio port.

Block 503 detects user interaction with the device and the LUT 501 is populated with detected sensor data as shown in block 505. This user interaction with the device can be detected by multiple means of data collection. The device is configured to recognize several forms of input from the user, for example, a button press or touch input; a mouse input; or a sensor could detect motion or gesturing from a user via a gyroscope, accelerometer, proximity sensor, or an optical sensor; or spoken user requests for playing multimedia (video/audio) may be detected by a microphone.

In operation 510 a second look-up table (LUT) is monitored or observed by a processor to determine which are the two best performing audio ports. The two best performing audio port designations are placed into the second LUT, designated as “Best Table”. The Best Table is configured to hold at least two best performing audio port designations at any one time; and herein is labeled as a Best Table 515. Best Table 515 can hold the minimum number of audio ports that are desired to be active, and will likely hold two or greater audio port designations.

In one illustrative embodiment the audio ports in Best Table 515 cannot be deactivated. They are static until Best Table 515 is repopulated through the flow chart. As such, a failsafe is provided to ensure that all ports are not deactivated at once.

During output of audio by the portable electronic device, i.e., mobile communication 100, for example, one or more sensors are sampled per a specified clock rate. The specified clock rate may be adjustable. Accordingly, the sensors can also be sampled continuously. Operation 520 of flowchart 500 in FIG. 5 provides instruction to monitor the LUT for subsequent adjustment or change in detected values of an audio port.

Operation 530 is configured to adjust audio ports 1-N via one or more processors. Therefore, an adjustment of an audio port can be performed by a processor and can include activating the audio port or deactivating the audio port. Alternatively, the volume of a specific audio port can also be either raised or lowered. The adjustment of one or more audio ports can be impacted by a change in a sensor value (i.e., a delta), and a threshold value for the sensor can be normalized, although it need not be. Operation 530 observes the range value [R] for each audio port from LUT 501.

A comparison value to a predetermined value will enable a determination of whether a specific audio port is adjusted. Upon a finding or determination that the sensor value is below the threshold value, the remaining value is slotted within a predetermined first range for adjusting the audio port in one manner. A predetermined second range may cause the audio port to be adjusted in another and different manner. Therefore, the sensor reading can influence either the first or second ranges [R] corresponding to the audio port. Specifically, the number of possible ranges and what range the delta will fall into can cause the volume of the audio port to either be deactivated or alternatively be adjusted up or down, for example.

Operations 532, 534 and 536 control the volume adjustment, activation and deactivation of the audio port, respectively. A feedback loop to operation 520 exists for additional monitoring of the LUT for additional audio ports after an inquiry 538 of whether the last audio port has been either activated, deactivated, or had its volume adjusted up or down, or had specific audio characteristics adjusted, for example bass, treble, equalization, or speaker balance. A further inquiry 540 analyzes whether a change in sensor data has occurred in the LUT, if so then a feedback loop to operation block 503 is shown for further monitoring and populating of sensor data within the LUT. Operation 542 causes processor to wait for a change in the sensor level and returns to operation 540 for further analysis, until the change in the sensor data has occurred in the LUT.

FIG. 5B illustrates different possible ranges [R] for assignment to a sensor value. Data taken at each sensor may be compared to a threshold value and normalized. The normalized delta, i.e., amount of sensor value change [D] from the threshold value is subsequently assigned a range value [R]. The [R] value is utilized by an algorithm within a processor to determine what action should occur at each audio port.

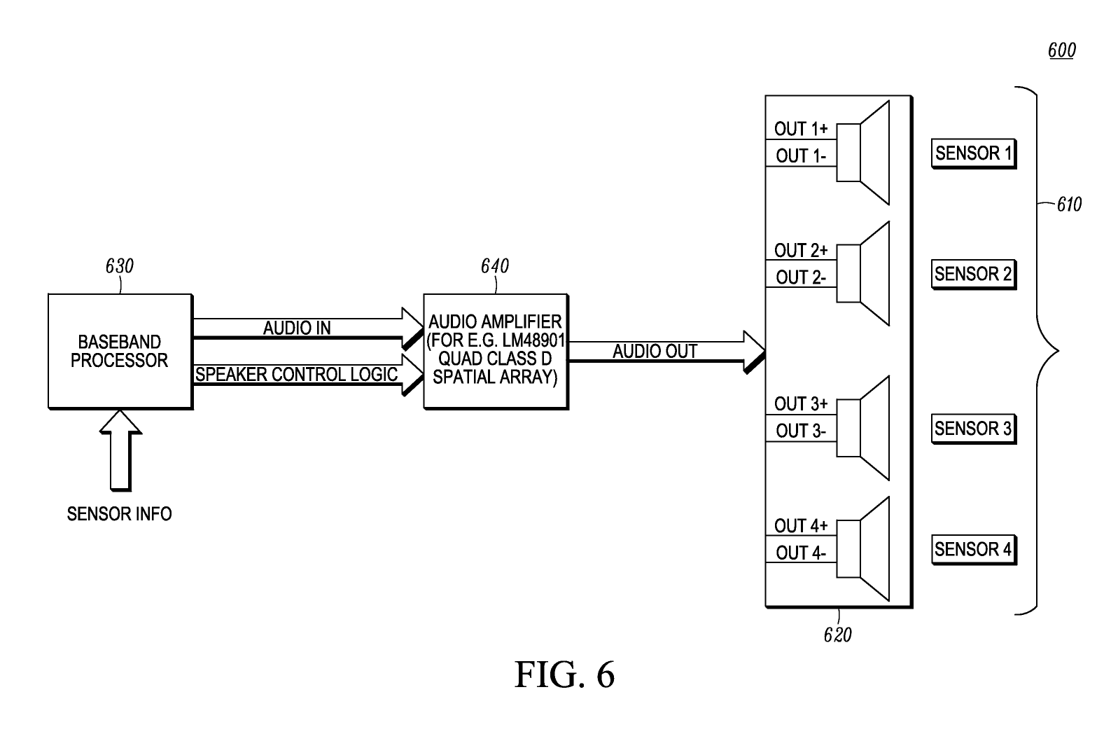

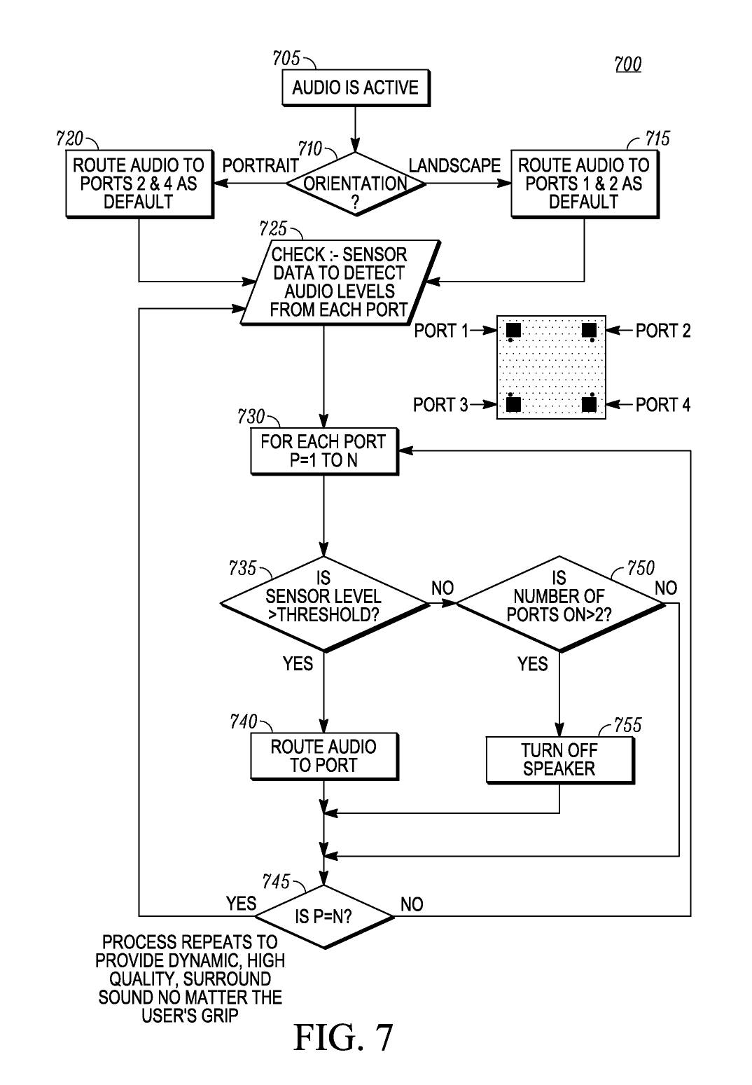

FIG. 6 illustrates an example block diagram 600 that includes several sensors 610 coupled electronically to monitor output of several audio ports or output transducers 620. A baseband processor 630 is configured to accept sensor information as an input. Baseband processor 630 controls audio input signaling with integrated control logic. An audio amplifier 640 operates on the audio input signal and produces an amplified audio output signal for manipulation by output transducers 620. Control logic as constructed and illustrated either in FIG. 5 or FIG. 7 enables baseband processor 630 to determine audio port activation.

FIG. 7 illustrates one example embodiment of a methodology, as depicted in flowchart 700, for employing a microphone (or any other type of input device) of the mobile communication device 100 as an input sensor. Mobile communication device 100 is configured as a portable electronic device having four audio ports located in corner layouts as depicted. Operation 705 of flowchart 700 monitors mobile communication device 100 for active audio. Operation 710 determines the physical orientation of device 100 when audio is active. A determination of a physical landscape orientation of device 100 causes operation 715 to route audio to ports 1 & 2 as default ports that likely will not become obstructed by a user grasping the device. Similarly, a determination of physical portrait orientation of device 100 causes operation 720 to route audio to ports 2 & 4 as default ports that likely will not become obstructed by a user grasping the device.

Operation 725 checks sensor data from a microphone placed near the audio ports to detect audio levels from each audio port as the audio is routed to predetermined audio ports. Depending on the type of input sensor, the sensor threshold value will be a large or small number. This data point may be normalized at this step and stored into the LUT as its normalized value, such that any comparison of the sensor data in the LUT will follow one formula. If not normalized, each sensor type will have its own specific formula dealing with the threshold levels and will need to be considered with a unique equation during operation 735.

Operation 730 causes each audio port (P), where P=1 to N to be analyzed. Specifically, operation 735 determines the sensor level of the sensor associated with the audio port and compares the sensor level to a predetermined threshold. If operation 735 determines that the sensor level is greater than the predetermined threshold, active audio may be routed by operation 740 to the associated or corresponding audio port. If all audio ports have been determined to receive routed audio in operation 745, that is P=N, then continuing sensor data checks are performed by operation 725. Where all audio ports have not been routed with audio, the process continues for each remaining port. The process repeats to provide dynamic, high quality, surround sound for the portable electronic device despite an obstruction on one or more audio ports, for example, caused by a device user's grip proximate one of the audio ports on the device.

When evaluating sensor data at step 735, it may be determined that adjusting the volume of the output speaker (up or down) rather than completely activating/deactivating the speaker, will result in acceptable performance. In this case, each sensor's data point can be interpreted at three levels, “good,” “acceptable,” or “poor.” At least two “good” audio outputs are desired, but if this is not possible, “acceptable” speakers can be used by adjusting the volume level up or down as necessary. These levels can be indicated by the “Range” element in the LUT. A Range of “2” represents “good,” Range of “1” represents “acceptable,” Range of “0” represents “poor.”

Where operation 735 determines that sensor level is less than a predetermined threshold, operation 750 determines whether the number of active audio ports is greater than 2. If affirmative that more than two active audio ports exist, then operation 755 turns off one audio port before operation 745 determines that all audio ports have received routed audio, that is P=N.

The flowcharts and block diagrams in the figures illustrate, by way of example, the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The present invention also can be embedded in a computer-readable storage device, such as a computer program product or other data programs storage device, readable by a machine, tangibly embodying a program of instructions executable by the machine to perform methods and processes described herein. The computer-readable storage device can be, for example, non-transitory in nature. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A portable electronic device including multiple audio ports, comprising:
a sensor for determining orientation of the portable electronic device;
a plurality of sensors placed near each audio port for sampling whether each audio port is obstructed; and
a processor for activating one or more unobstructed audio ports and deactivating one or more obstructed audio ports.

2. The portable electronic device claimed in claim 1, further comprising a look up table comprising parameters corresponding to the multiple audio ports and the plurality of sensors.

3. The portable electronic device claimed in claim 2, wherein the parameter for the plurality of sensors includes a sensor measurement level and predetermined threshold value.

4. The portable electronic device claimed in claim 1, wherein the plurality of sensors are selected from a group consisting of microphones, proximity sensors, pressure sensors, microelectromechanical sensors, nanotechnology sensors, infrared sensors, imaging sensors, capacitive touch sensors, speaker impedance sampler, passive touch sensors, resistive touch sensors, gyroscope sensors, and accelerometer sensors.

5. The portable electronic device claimed in claim 1, wherein the plurality of sensors include a multi-port sensor capable of scanning more than one audio port of the multiple audio ports for an obstructed audio port.

6. The portable electronic device claimed in claim 1, wherein the plurality of sensors is equal to the multiple audio ports.

7. The portable electronic device claimed in claim 5, wherein the plurality of sensors are less than the multiple audio ports.

8. A method for deactivating and activating audio ports in a portable electronic device based on determination of blockage of the audio ports, comprising determining, via a processor, orientation of the portable electronic device;
routing, via a processor, an audio signal to predetermined audio ports;
sampling, via a processor, each sensor that is associated with each audio port for acceptable corresponding sensor output;
activating, via a processor, each audio port where the sensor level is found acceptable;
deactivating, via a processor, each audio port where the sensor level is found unacceptable; such that at least two audio ports remain activated.

9. A method for deactivating, activating, or adjusting audio ports in a portable electronic device based on determination of blockage of the audio ports, comprising:
determining, via a processor, whether at least one audio port is active in the portable electronic device;
populating, via a processor, a first look up table with sensor data for each audio port;
populating, via a processor, a second look up table with at least two best performing audio ports as determined by the first look up table;
activating, via a processor, each audio port where the sensor level is found acceptable;
deactivating, via a processor, each audio port where the sensor level is found unacceptable; and also keeping two audio ports placed in the second look up table activated.

10. The method of claim 9, wherein the first lookup table comprises sensor data about monitored sensor levels, detected speaker input impedance changes, comparison of threshold levels, activation status changes of audio ports.

11. The method of claim 9, further comprising:
detecting changes in the threshold levels.

12. The method of claim 9, further comprising:
detecting changing activation status of the audio ports based on the detected threshold levels.

13. The method of claim 9, wherein the sensor data in the first lookup table is continuously updated.

14. The method claimed in claim 9, wherein adjusting audio ports includes increasing or decreasing volume.

15. The method claimed in claim 9, wherein adjusting audio ports includes adjusting audio characteristics.

16. The method claimed in claim 9, wherein the audio characteristics are selected from a group comprising treble, bass, equalization, speaker balance.
